(19) United States
(12) Patent Application Publication
(10) Pub. No.: US 2002/0047020 A1
(43) Pub. Date: Apr. 25, 2002

(54) Vending system

(76) Inventor: David Robert Dudek, Katy, TX (US)

Correspondence Address: Yukiko Iwata, Shell Oil Company, Legal - Intellectual Property, P.O. Box 2463, Houston, TX, 77252-2463, US

(21) Appl. No.: 09/843,337

(22) Filed: Apr. 25, 2001

(30) Foreign Application Priority Data
Apr. 25, 2000 (EP) 00303478.2

(51) Int. Cl. G07F 11/00

(52) U.S. Cl. 221/9; 221/13

(57) ABSTRACT

A vending system is provided for the dispensing of products, wherein said vending system comprises means for sampling the sensory characteristics of a product, prior to the dispense of the product. A process is provided for the dispense of a product from a vending system, wherein the consumer or user selects the product to be dispensed from the interface of the vending system and said product is dispensed from the vending system into a storage container located in the dispense point of the vending system, wherein prior to the dispense of the product, the consumer or user may sample the sensory characteristics of said selected product. The sensory experience may be commenced with the use of a product experience button on a vending system, prior to dispense of a product from the vending system.

This application claims priority to the foreign application filed on Apr. 25, 2000, in Europe and having a serial number of 00303478.2.

### FIELD OF THE INVENTION

The present invention relates to a vending system.

### BACKGROUND OF THE INVENTION

The number of product variants offered by a product manufacturer for a particular product line may be large.

For example, in the area of liquid fabric softeners, a cleaning product manufacturer may have 5 or 6 different fragrances (each with a separate identifying colour), 3 or 4 different pack sizes, and offer product in both ready-to-use and concentrate form. This can mean upwards of 40 different product variants being stocked at one particular retail site for just one product line.

There are, in addition, a number of “performance” additives that the cleaning product manufacturer may add to cleaning products. Such additives may include, for example, anti-bacterial agents, bleaching agents and agents to prevent creasing of fabrics.

By “performance” additives in the present invention, is meant that the presence of said additives has a particular effect on a process, and the results obtained thereby.

In addition to the presence of “performance” additives, the consumer uses sensory characteristics such as colour and fragrance as primary factors in deciding whether to purchase one particular product over another.

Such a decision is facilitated by the consumer being able to open a product storage container and sample the product.

By “sample” in the present invention, is meant being able to use one of the five senses in order to assess the sensory characteristics of the product. In the retail environment, the senses used will be primarily visual and olfactory. In other situations, the consumer may be offered the opportunity to taste a product prior to purchase.

Filling machines may dispense a wide variety of products from the same machine. Such machines may include production line filling machines and vending systems which are designed to fill containers at sites located in, for example, retail outlets, offices and other workplaces.

By “vending system” in the present invention, is meant a filling machine that dispenses product in response to one or more selections that are input into the machine by the consumer or user. Such a system may be operated by coin, token, card or other suitable means.

By “dispense point” in the present invention, is meant the region of the vending system in which a storage container is placed in order for product to be dispensed.

Vending systems are known in the art for dispensing beverages such as tea and coffee according to the precise selection made by the user. Such beverages may also be made by the user according to traditional methods. However, in many situations, where time is short, or facilities are limited, the use of vending system for the dispensing of beverages offers a convenient alternative. However, it will be appreciated that such a system merely serves to automate a process that the user may otherwise perform themselves. It will be appreciated that whilst the user may select said beverage from a number of possible combinations, it is not possible for the user to sample the beverage prior to actual dispense of a full cup of said beverage. Thus, unlike with traditional methods, it is not possible for the user to adjust the characteristics of the beverage after dispense, for example, to increase the strength of the beverage, or to add more milk or sugar. In the case that the dispensed product does not meet the requirements of the user, it is necessary to discard the dispensed beverage and to repeat the process.

Whilst it is possible with relatively inexpensive products such as beverages to discard unwanted product, the problem is exacerbated when vending systems are used in order to dispense more expensive commodities.

### SUMMARY OF THE INVENTION

According to the present invention there is provided a vending system for the dispensing of products, wherein said vending system comprises means for sampling the sensory characteristics of a product, prior to the dispense of the product.

According to the present invention, there is further provided a process for the dispense of a product from a vending system which comprises:

(i) the consumer or user selects the product to be dispensed from the interface of the vending system; and

(ii) said product is dispensed from the vending system into a storage container located in the dispense point of the vending system,

wherein prior to the dispense of the product, the consumer or user may sample the sensory characteristics of said selected product.

The incorporation of a sampling step prior to dispense allows the consumer to assess the sensory characteristics of the product before making the decision to purchase said product.

By “sensory characteristics” in the present invention, is meant the look, smell, taste, aural or tactile nature of a product.

As well as in conventional dispensing situations, wherein the consumer selects product from a fixed number of product alternatives, such a step is of particular importance in situations wherein the consumer has greater control over the characteristics of the product to be dispensed. That is to say, where the precise formulation of a product is to be determined by the consumer or user by allowing the consumer or user to select from ingredients and determine the mix of ingredients according to need or personal preference.

Thus, it is also possible for the consumer or user to alter the sensory characteristics of a product according to their own personal preference, in addition to tailoring the identities and amounts of “performance” additives included in the product, according to their specific requirements.

For example, the characteristics and colours of cosmetic products may be tailored for specific skin types, and the product sampled prior to dispense; paint colour may be sampled prior to the mixing and dispensing of a large batch of product; cleaning products may be sampled with respect to colour and fragrance prior to mixing and dispensing of the customised cleaning product.

Depending upon the sensory characteristics required, the consumer may be offered a number of discrete choices or in the case of characteristics such as colour and fragrance, the consumer may be given the option of further customising the sensory characteristics of the product by mixing together one or more colours and/or fragrances from a large palette of colours and/or fragrances.

Sampling may occur by any means known in the art that is appropriate to the sensory characteristics that are to be sampled. For example, in the case of fragrance, sampling may occur by means of an aroma jet, an atomiser or any similar feature commonly used in the art that may be conveniently built into the functionality of the vending system.

Sampling may be controlled by a “product experience button” housed on the interface of the vending system, which will operate after the consumer has made the customisation selection during the dispensing process.

By “product experience button” in the present invention is meant any conventional operating mechanism housed on the interface of the vending system, which the consumer may employ in order to commence sampling of the sensory characteristics of a product, prior to dispense from a vending system.

According to a preferred embodiment of the present invention, said vending system and process for the dispense of a product allow for a product to be customised, optionally reconstituted and dispensed from a vending system at the point-of-sale of said product.

According to a preferred embodiment of the present invention, said vending system and process for the dispense of a product allow for the simultaneous multiple customisation, optional reconstitution and/or dispensing of products.

Such an arrangement is particularly useful, and allows queues to be minimised during peak traffic periods by providing multiple dispense points, each point being capable of producing any mix of concentrate or reconstituted product, and in any volume according to user choice, simultaneously.

Preferably, the vending system of the present invention is connected to a plurality of interfaces and/or one or more further vending systems, such that any interface may be used to select and customise the product and that any dispense point may be used to dispense the product. Thus, it will be appreciated that the interface may be located on the vending system or at a location distinct from the vending system.

The vending system of the present invention serves to allow concentrates with different physical characteristics, such as solids and liquids, to be mixed and optionally reconstituted together

It will be appreciated that reconstitution is an optional step in the customisation of products, and is dependent upon the requirements of the consumer. For example, for ease of transport the consumer may wish to leave the customised product in concentrated form until said product is in the use environment, for example in the consumer's home, whereupon said product may be reconstituted by the consumer or user. However, in order to ensure that the reconstituted product is of uniform quality without any change in the degree of reconstitution of constituents, in a preferred embodiment of the present invention, said products will be reconstituted prior to dispense from the vending system.

By “point-of-sale” in the present invention is meant anywhere where the vending system is located. It is most likely that the point-of-sale (POS) will be in a retail environment or a kiosk. However, such a vending system may be located in a stand-alone location, or in any location wherein there is a large demand for said products, for example a hotel, housing complex or hospital.

By “concentrate” in the present invention is meant a generic concentrate which contains only the basic formulation components in concentrated form. Said concentrate will be typically unscented and may be further customised by the addition of one or more additives so as to provide further features and properties to the subsequently reconstituted product. Said additive sources may be of disparate types, for example, liquids and solids. Said concentrate will be typically delivered in bulk to the vending system. It will be appreciated that said additives may also be concentrated. Said additives may be “performance” additives and/or they may provide the sensory characteristics of the product.

The combination of many product variants into the delivery of a single generic concentrate for subsequent customisation, simplifies the supply chain, increases supply chain responsiveness and lowers the total supply chain inventory.

In the present invention, product concentrate sources are dosed according to the consumer's or user's instructions and final requirements. Said instructions are conveniently made through an interface located on the vending system. Said interface may be of any kind commonly used in the art. Preferably, said interface will be a touch-sensitive screen.

Concentrate and/or diluent sources will be housed in bulk reservoirs inside the vending system, or fed into the vending system from an external location through conduits.

In the case of said vending system comprising multiple dispense points, said dispense points may be conveniently linked in parallel to the same concentrate and/or diluent sources.

Once the desired concentrate sources have been dosed to achieve the desired chemical properties and/or physical properties and/or sensory characteristics for the product, the customised concentrated product may be dispensed, or in a preferred embodiment, one or more diluents may be added to reconstitute the product to achieve its desired concentration.

Thus, optional reconstitution with diluent offers the consumer the choice of purchasing the product in more traditional ready-to-use forms or in a more concentrated form. As well as ease of transport, such an option allows the consumer to customise strength of the product according to their demands.

Said optionally reconstituted product may then be dispensed into a storage container.

The nature of the storage container that may be employed in the present invention is not limited and it is possible to dispense the optionally reconstituted product into a standard external storage container of any kind known in the art.

The vending system and process of the present invention may be conveniently used for a wide variety of materials such as foodstuffs, beverages, household products such as detergents, and automotive products such as lubricants.

### BRIEF DESCRIPTION OF THE DRAWING

The present invention will now be described by way of example with reference to the accompanying drawings. It is to be noted, however, that the accompanying drawings illustrate only some embodiments of the invention and are therefore not to be considered limiting of its scope, because the invention may admit to other equally effective embodiments.

FIG. 1 is a functional block diagram of the process of the present invention.

FIG. 2 is a schematic view of a system using the process described in FIG. 1.

### DETAILED DESCRIPTION OF THE INVENTION

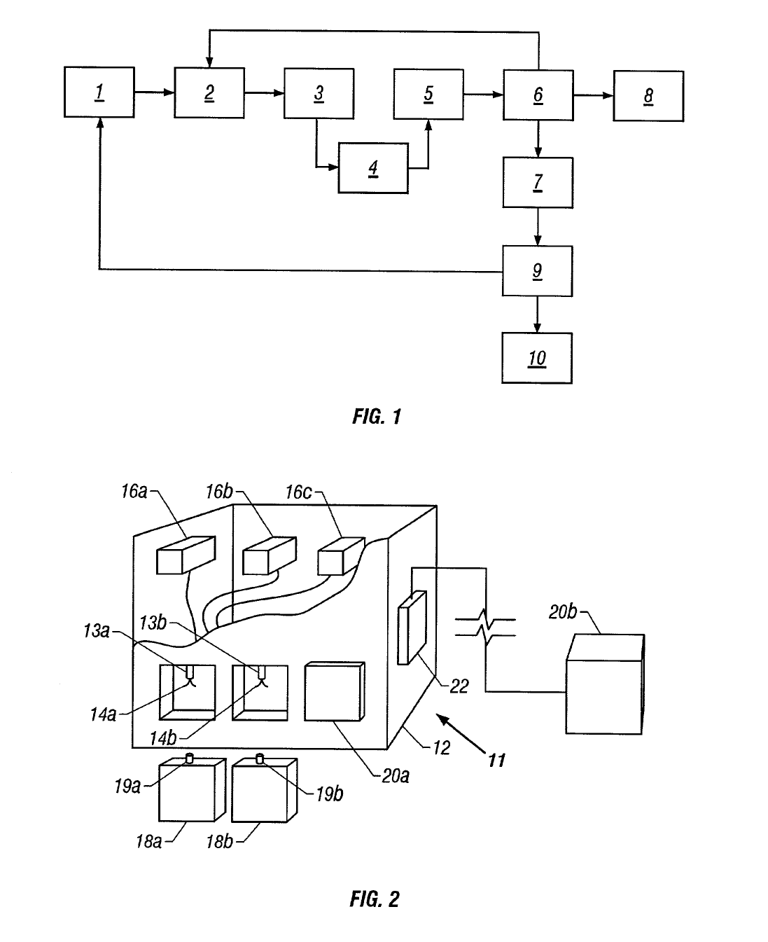

Referring to FIG. 1, the consumer decides to purchase product and places in step 1 a storage container in the dispense point of the vending system.

Said consumer selects in step 2 the type of product to be dispensed from the available options that are shown on the interface of the vending system.

It will be appreciated that depending upon the nature of the products and their compatibility, it may be possible to select multiple product types for a single product dispense.

Said consumer then customises in step 3 the product's sensory characteristics from the available options that are shown on the interface of the vending system for that particular product type. Said options may include, for example, fragrance and colour. Said consumer further selects any “performance” additives that may be required from the available options that are shown on the interface of the vending system for that particular product type.

Said consumer may then sample in step 4 the sensory characteristics of the product selection that has been made.

Said consumer then selects in step 5 the amount of product required from the available options that are shown on the interface of the vending system, and whether the product is to be reconstituted or dispensed as a concentrate.

Said consumer then checks and confirms in step 6 that the product specification shown on the interface of the vending system is correct, prior to dispense in step 7 of said product from the vending system.

If the product specification is incorrect, the consumer may indicate this in step 6 on the interface of the vending system and may re-start the process of step 2 of the present invention, or said consumer may terminate the process in step 8.

Upon product dispense in step 7, and removal of the storage container from the dispense point of the vending system, the consumer is given the choice in step 9 of repeating the process at step 1 in order to dispense further products, according to their individual requirements.

If the consumer does not require any further products, the process ends in step 10.

FIG. 2 is a schematic view of a system using the process described in FIG. 1. The system described in FIG. 2 is merely exemplary of one system that can be used with that process and is not restricted to the number of elements shown, individual arrangements of the elements, relative size, or shape. The system shown is merely exemplary of one embodiment and can be arranged in different ways, added to, and subtracted therefrom.

A vending system 11 can include one or more filling machines 12. In some embodiments, the filling machine may be a vending machine or vending system. The dispensing system may be located in commercial or retail establishments, at point of use, in manufacturing facilities, and in other places where the customisation of consumer products may be performed. The vending system 11 can include one or more dispensing points 13a, 13b. The dispensing points can be used to dispense product 14a, 14b discharged from the dispensing points. The number of dispensing points depends upon the relative use of the product, the size of the vending system, and other factors. Thus, while two dispensing points are shown, it is to be realised that one or more dispensing points can be associated with the system. Further, multiple filling machines 12 can be included with the vending system 11. Consistent with the teaching of the description herein, one or more reservoirs 16a, 16b, 16c can be used to hold the concentrate and/or diluent sources and other additives described herein. The reservoirs can be coupled to the dispensing points 13a, 13b and controlled by one or more interfaces 20a, 20b.

Further, the vending system 11 can include one or more interfaces 20a, 20b to control the system sources, additives, and materials dispensed. In some embodiments, the interface 20a may be local to the vending system 11. In other instances, the interface can be a remote interface 20b that can be linked to the filling machine 12 in some manner known to those with ordinary skill in the art. The interfaces can be used to select and otherwise customise the product dispensed through the dispensing prints. A communicative device 22, such as a modem, link, or other communication devices, can be used to establish the link between the filling machine 12 and the interface 20b.

One or more containers 18a, 18b, can be used to hold the one or more dispensed product 14a, 14b. The dispensed product can be dispensed into the containers through one or more fill apertures 19a, 19b disposed on the containers.

While the foregoing is directed to various embodiments of the present invention, other and further embodiments may be devised without departing from the basic scope thereof. For example, the various methods and embodiments of the invention can be included in combination with each other to produce variations of the disclosed methods and embodiments. Also, the directions such as “top,” “bottom,” “left,” “right,” “upper,” “lower,” and other directions and orientations are described herein for clarity in reference to the figures and are not to be limiting of the actual device or system or use of the device or system. The device or system may be used in a number of directions and orientations. Further, the order of steps can occur in a variety of sequences unless otherwise specifically limited. The various steps described herein can be combined with other steps, interlineated with the stated steps, and/or split into multiple steps.

1. A vending system for the dispensing of products, wherein said vending system comprises means for sampling the sensory characteristics of a product, prior to the dispense of the product.

2. The vending system according to claim 1, wherein said products are customised, optionally reconstituted and dispensed from said vending system at the point-of-sale of said product.

3. The vending system according to claim 1, wherein said vending system comprises means for the simultaneous multiple customisation, optional reconstitution and/or dispensing of products.

4. The vending system according to claim 1, wherein said vending system is connected to a plurality of interfaces and/or one or more further vending systems, such that multiple interfaces may be used to select and customise the product and that multiple dispense points may be used to dispense the product.

5. The vending system according to claim 2, wherein said vending system is connected to a plurality of interfaces and/or one or more further vending systems, such that multiple interfaces may be used to select and customise the product and that multiple dispense points may be used to dispense the product.

6. The vending system according to claim 3, wherein said vending system is connected to a plurality of interfaces and/or one or more further vending systems, such that multiple interfaces may be used to select and customise the product and that multiple dispense points may be used to dispense the product.

7. A process for dispensing a product from a vending system, comprising:
(a) allowing a consumer or user to select the product to be dispensed from an interface of the vending system; and
(b) dispensing said product from the vending system into a storage container,
wherein prior to the dispense of the product, the consumer or user may sample the sensory characteristics of said selected product.

8. The process according to claim 7, further comprising customising, optionally reconstituting and dispensing said product from a vending system at the point-of-sale of said product.

9. The process according to claim 7, wherein said process includes simultaneous multiple customisation, optional reconstitution and/or dispensing of products.

10. The process according of claim 9, further comprising:
(a) placing a storage container in the dispense point of the vending system;
(b) selecting a type of product to be dispensed from available options that are shown on the interface of the vending system;
(c) customising the product's sensory characteristics from available options that are shown on the interface of the vending system for that particular product type;
(d) optionally selecting any performance additives from available options that are shown on the interface of the vending system for that particular product type;
(e) sampling the sensory characteristics of the product type selection that has been selected;
(f) selecting an amount of product, whether the product is to be reconstituted or dispensed as a concentrate, or a combination thereof from available options that are shown on the interface of the vending system;
(g) dispensing the product from the vending system if the product selection is correct;
(h) optionally re-starting the process or terminating the process if the product specification is incorrect; and
(i) allowing repeating the process in order to dispense further products.

11. The process according to claim 7, wherein the products are cleaning products.

12. The process according to claim 8, wherein the products are cleaning products.

13. The process according to claim 9, wherein the products are cleaning products.

14. The process according to claim 10, wherein the products are cleaning products.

15. A process for dispensing a product, comprising:
(a) using a product experience button on a vending system to commence sampling of sensory characteristics of a product; and then
(b) dispensing the product from the vending system.

16. The process according to claim 15, wherein the products are cleaning products.

17. The process according to claim 15, further comprising customising, optionally reconstituting and dispensing said product from a vending system at the point-of-sale of said product.
